(19) United States
(12) Patent Application Publication
(10) Pub. No.: US 2011/0170727 A1
(43) Pub. Date: Jul. 14, 2011

(54) Boundary Microphone

(76) Inventors: Hiroshi Akino, Tokyo (JP); Satoshi Yoshino, Tokyo (JP)

(21) Appl. No.: 12/968,722

(22) Filed: Dec. 15, 2010

(30) Foreign Application Priority Data
Jan. 8, 2010 (JP) 2010-002771

(51) Int. Cl. H04R 11/04

(52) U.S. Cl. 381/361

(57) ABSTRACT

A boundary microphone includes a base, a microphone unit that is mounted onto the base and converts voice into electrical signals, and a pressure-sensitive switch of membrane type for an on/off operation of output signals from the microphone unit. The pressure-sensitive switch is physically isolated from the base, and is supported at the bottom thereof by a switch support comprising a hard material.

### TECHNICAL FIELD

The present invention relates to a boundary microphone that has a pressure-sensitive switch switching output signals from a microphone unit and is primarily used on a table.

### BACKGROUND ART

Boundary microphones have pressure-sensitive switches switching output signals from microphone units and are used on tables. The boundary microphones, which are used on desks or floors in TV studios and conference halls, are also called surface mount microphones (on-surface sound pickup microphones). For example, as is disclosed in Japanese Unexamined Patent Application Publication No. 2008-288933, a boundary microphone is primarily used on a table; thus, a microphone unit and an accompanying circuit are incorporated into a low-profile flat casing in many cases so that its existence is unnoticed.

With reference to FIG. 3, a boundary microphone 11 has a flat, low profile at the periphery and includes a metal base 10 having an opening on the top, a microphone cover 15 that is composed of a metal plate, such as a punching plate, having a large number of openings (sound inlet openings) and covers the top surface of the base 10, and a support 12 that is composed of a flexible material and is disposed under the bottom of the base 10. A microphone unit 13 is accommodated in a space defined by the base 10 and the cover 15. In general, the microphone unit 13 is of a capacitor type. The boundary microphone 11 is placed on a table 14.

With reference to FIGS. 3 and 4, a typical boundary microphone 11 has a switching unit 1 of an appropriate type, such as a membrane, electrostatic capacity, or mechanical type, which allows an operator to control the on/off switching of output signals from the microphone unit 13, for example, in the front thereof. Use of a push switch having click feeling generates noise due to vibration of the microphone itself by the switching operation with click feeling. Accordingly, a membrane switch is generally used for on/off switching of output signals in a boundary microphone 11.

As shown in FIG. 4, the membrane pressure-sensitive switch 1 includes a membrane 5 bendable by press by an operator and a printed circuit board 3 having a circuit pattern to check for electrical connection. Pressing the membrane 5 to be put into contact with the pattern leads to switching on of the pressure-sensitive switch 1, while releasing the membrane 5 from pressing leads to switching off. Unfortunately, some motion such as transfer of documents on the desk may lead to vibration of the boundary microphone 11 and thus generation of noise. In order to prevent vibration noise, a support 12 composed of a soft material is attached to the entire bottom surface of the boundary microphone 11.

Such a soft support 12, however, causes sinking of the boundary microphone 11 when the user presses the pressure-sensitive switch 1, resulting in delayed or awkward movement of the pressure-sensitive switch 1 in some cases. The awkward movement of the pressure-sensitive switch 1 gives the operator feeling of the switch 1 being hardly pressed. As a result, the operator press the pressure-sensitive switch 1 with excess force or applies concentrated pressure to the switch 1 using a ball point pen or nail for normal operation. This may damage the pressure-sensitive switch 1 in some cases. Furthermore, the pressure-sensitive switch 1 is in mechanical contact with the top face of the base 10, as shown in FIGS. 3 and 4. This configuration limits a reduction in noise caused by vibration of the boundary microphone 11 itself on the switching-on operation by the operator. Accordingly, this switch has a disadvantage of mixing of noise to output signals from the microphone by propagation of mechanical vibration during the switching operation to the microphone unit 13.

### SUMMARY OF INVENTION

An object of the present invention is to provide a boundary microphone including a pressure-sensitive switch that is insusceptible to vibration noise caused by vibration of the microphone body when an operator turns on the switch and that can be simply operated without damage by the operator.

A boundary microphone in accordance with the present invention includes a base; a microphone unit mounted on a base, the microphone unit converting voice into electrical signals; and a pressure-sensitive switch of membrane type for an on/off operation of output signals from the microphone unit, wherein the pressure-sensitive switch is physically isolated from the base and is supported at the bottom thereof by a switch support comprising a hard material.

In the present invention, the pressure-sensitive switch is physically isolated from the base so that vibration occurring on pressing the switch does not propagate. Such a structure can reduce vibration noise caused by vibration of the boundary microphone body occurring on the switching operation of the pressure-sensitive switch by the user. Furthermore, the switch support provided on the bottom of the pressure-sensitive switch facilitates the on/off operation of the pressure-sensitive switch by the operator. Accordingly, the boundary microphone can be readily operated without damage of the pressure-sensitive switch.

### BRIEF DESCRIPTION OF DRAWINGS

FIG. 1 is a cross-sectional view of a boundary microphone of an embodiment of the present invention;

FIG. 2 is an enlarged cross-sectional view of a pressure-sensitive switch of the boundary microphone shown in FIG. 1;

FIG. 3 is a cross-sectional view of a conventional boundary microphone; and

FIG. 4 is an enlarged cross-sectional view of a pressure sensitive switch of the boundary microphone shown in FIG. 3.

### DESCRIPTION OF EMBODIMENTS

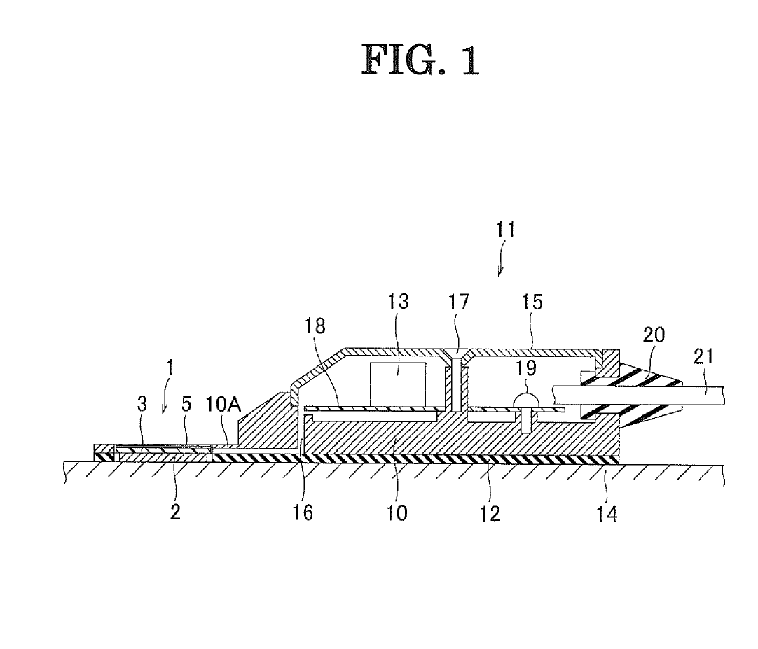

Embodiments of a boundary microphone in accordance with the present invention will now be described with reference to the attached drawings. With reference to FIG. 1, the boundary microphone 11 primarily includes a flat metal base 10 having an opening on the top; a metal microphone cover 15 having a large number of openings (sound inlet openings), the cover 15 being mounted on the base 10 so as to cover the top face of the base 10; a pressure sensitive switch 1; a switch support 2 supporting the pressure-sensitive switch 1; an external thread 17, a printed circuit board 18 for the boundary microphone 11; and a microphone unit 13. A microphone cord 21 and a cord bush 20 are attached to the tail end (right end in FIG. 1) of the base 10. A support 12 is disposed on the entire bottom surface of the base 10. The boundary microphone 11 is disposed on a desk 14. The support 12 may be composed of a nonflexible material, but preferably be composed of a flexible material that can absorb vibration of the entire boundary microphone 11. The support 12 of the boundary microphone 11 is more preferably composed of a rubber that can absorb vibration.

The space defined by the base 10 and the microphone cover 15 accommodates the printed circuit board 18 and the microphone unit 13. The printed circuit board 18 is fixed in the interior of the boundary microphone 11 with a thread 19. The microphone unit 13 may be accommodated after being mounted onto the printed circuit board 18 or may be accommodated independently of the printed circuit board 18. The printed circuit board 18 is connected to an end of the microphone cord 21, the other end of the microphone cord 21 being extracted from the base 10 through the cord bush 20. The microphone cover 15 is detachably fixed to the base 10 with a screw. In FIG. 1, fixing is achieved at a single point using one external thread 17 and one boss protruding from the base 10 in view of appearance or design. Instead, fixing may be achieved at multiple points. Alternatively, the microphone cover 15 may be fixed to the base 10 by any other means such as fitting.

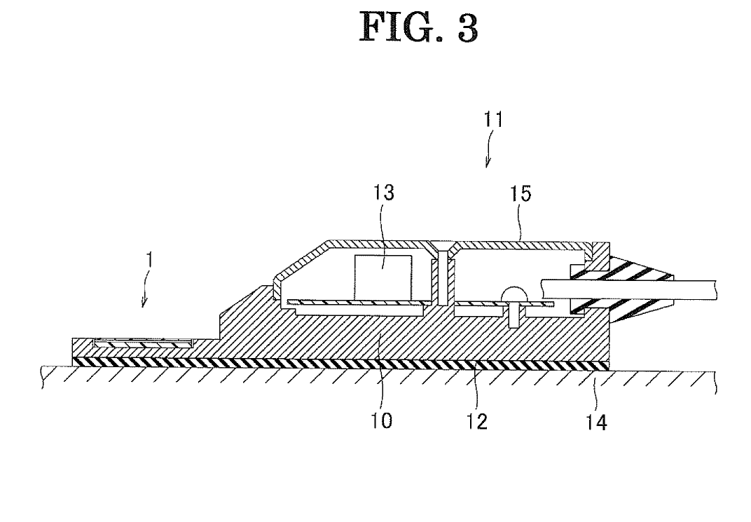

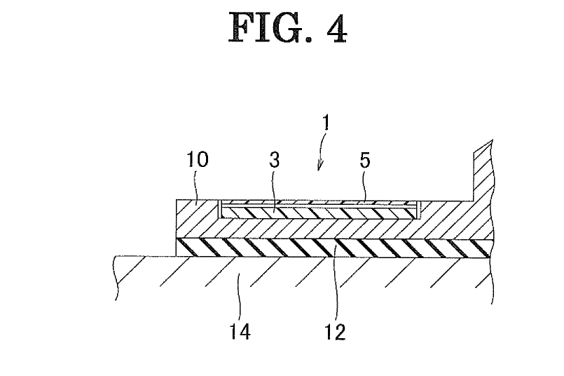

The base 10 has a projection 10A projecting from the front bottom. The pressure-sensitive switch 1 is disposed within a hole vertically passing through the projection 10A. The pressure-sensitive switch 1 is disposed within the hole of the projection 10A of the base 10, unlike the conventional one shown in FIGS. 3 and 4 where the switch is provided on the base 10. As a result, the periphery of the pressure-sensitive switch 1 is isolated from the base 10. In other words, the pressure-sensitive switch 1 is physically isolated from the base 10. The projection 10A may be oriented in any direction, and may be disposed at the side or the back of the boundary microphone 11. At the same time, the position of the pressure-sensitive switch 1 may be placed at any flat position, that is, at the side or the back. The pressure-sensitive switch 1 and the base 10 are separated by a buffer 4 that supports the pressure sensitive switch 1 at its periphery. The buffer 4 may be composed of any material, for example, rubber. The buffer 4 can be eliminated, but it facilitates damping support of the pressure-sensitive switch 1 by the base 10.

The pressure-sensitive switch 1 includes a membrane 5 and a printed circuit board 3 and is supported at the bottom thereof by a switch support 2 composed of a hard material. The switch support 2 is placed in a hole vertically extending through the support 12, the hole being aligned to the hole of the base 10 in a plan view. The switch support 2 lies at the bottom of the base 10 at the same level of the support 12. The peripheries of the switch support 2 are isolated from the support 12. The pressure-sensitive switch 1 is physically isolated from the base 10 such that the vibration of the pressure-sensitive switch 1 does not propagate to the body of the boundary microphone 11 or is attenuated even if it propagates to the body of the boundary microphone 11. The pressure-sensitive switch 1 therefore can be disposed at any other position other than the interior of the hole of base 10. For example, the pressure-sensitive switch 1 may be disposed on a flat plane defined by a cutout provided at tip of the projection 10A, and the switch support 2 is placed on the bottom of the pressure-sensitive switch 1. Preferably, the pressure-sensitive switch 1 is placed in a hole provided in the projection 10A of the base 10 so that users can readily press the pressure-sensitive switch 1. The switch support 2 may be composed of any hard material such as a plastic material.

As described above, the pressure-sensitive switch 1 is physically isolated from the base 10 so that the vibration of the pressure-sensitive switch 1 does not propagate to the body of the boundary microphone 11. This structure can prevent generation of vibration noise due to vibration of the boundary microphone 11 itself on the operation of the pressure-sensitive switch 1 by a user. In addition, the hard switch support 2 provided at the bottom of the pressure-sensitive switch 1 allows a user to switch on/off the boundary microphone 11 readily without damage of the pressure-sensitive switch 1.

The base 10 and the microphone cover 15 have a planar shape, such as a substantially quadrangular shape, and the body of the boundary microphone composed of these components may also have a substantially quadrangular shape. The base 10 may have any other planar shape, for example, a triangular shape. For a base 10 having a triangular planar shape, the microphone cover 15 also preferably has a triangular planar shape.

The base 10 is typically a zinc die-cast product. Alternatively, the base 10 may be a press-molded product of metal. The microphone cover 15 is typically composed of a punching plate (perforated plate) of iron or any other metal. A metal gauze may also be used instead of the punching plate.

In the case of a boundary microphone, the microphone unit 13 is a capacitor microphone unit including an impedance converter. The printed circuit board 18 includes a tone control circuit and a voice output circuit. The printed circuit board 18 is connected to an end of the microphone cord 21. The other end of the microphone cord 21 is extracted from the base 10 through a cord bush 20. In the case of a wireless microphone, the microphone case 1 has an antenna as a transmission means. An optical wireless microphone includes, for example, a light-emitting diode.

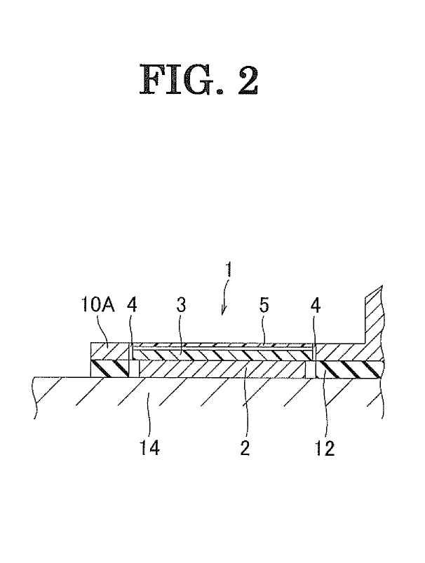

With reference to FIG. 2, the pressure-sensitive switch 1 is explained in further detail. The pressure-sensitive switch 1 includes a membrane 5 and a printed circuit board 3. The printed circuit board 3 of the pressure-sensitive switch 1 is bonded by any means to the upper face of the switch support 2 such that its patterned portion faces the membrane 5. The printed circuit board 3 of the pressure-sensitive switch 1 is a flexible printed circuit board on which a pattern of cupper foil is formed for detection of conduction. The pattern is preferably an interdigital pattern in which electrode elements of a first electrode pattern and electrode elements of a second electrode pattern alternately interdigitated. The pattern faces the membrane 5. When the pattern of the printed circuit board 3 of the pressure-sensitive switch 1 comes into contact with the membrane 5, the first electrode pattern is electrically connected to the second electrode pattern, so that the pressure-sensitive switch 1 turned on. A spacer may be provided between the membrane 5 and the printed circuit board 3 of the pressure-sensitive switch 1 at the periphery thereof to avoid malfunction of the pressure-sensitive switch 1 by their incidental contact. Preferably, the pressure-sensitive switch 1 includes a self-maintenance circuit to maintain the ON state after the printed circuit board 3 is detached.

In FIG. 1, a space 16 is provided between the printed circuit board 3 of the pressure-sensitive switch 1 and a printed circuit board 18 of the boundary microphone. The space horizontally extends between the base 10 and the support 12 and then upward to and in communication with the space of the interior of the boundary microphone 11. The flexible printed circuit board 3 of the pressure-sensitive switch 1 extends through the space 16 to the upper face of the printed circuit board 18 of the boundary microphone 11, and is electrically connected to the printed circuit board 18 of the boundary microphone 11. The ON/OFF operation of the pressure-sensitive switch 1 can be transmitted to the boundary microphone 11. The pressure-sensitive switch 1 can be electrically connected to the boundary microphone 11 in any way other than that described above.

An embodiment of the present invention has been explained above. The present invention, however, should not be limited to the embodiment. For example, the switch mechanism of the boundary microphone of the present invention should not be limited to the boundary microphone, but can also be applied to a microphone provided with a speaker that is used on a table.

What is claimed is:

1. A boundary microphone, comprising:
a base;
a microphone unit mounted on the base, the microphone unit converting voice into electrical signals; and
a pressure-sensitive switch of membrane type for an on/off operation of output signals from the microphone unit;
wherein the pressure-sensitive switch is physically isolated from the base, and is supported at the bottom thereof by a switch support comprising a hard material.

2. The boundary microphone of claim 1, wherein the pressure-sensitive switch is disposed in front of the boundary microphone.

3. The boundary microphone of claim 1, wherein the pressure-sensitive switch is disposed inside a hole provided at a protrusion of the base.

4. The boundary microphone of claim 1, further comprising a buffer member provided between the pressure-sensitive switch and the base.

5. The boundary microphone of claim 1, further comprising a support comprising a soft material disposed at the bottom of the base.

6. A boundary microphone, comprising:
a base;
a microphone unit mounted on the base, the microphone unit converting voice into electrical signals;
a pressure sensitive switch for an on/off operation of output signals from the microphone unit, said pressure sensitive switch being disposed in a hole in said base and physically isolated from said base; and
a switch support positioned under said pressure sensitive switch.

7. The boundary microphone of claim 6 further comprising a rubber support disposed on a bottom of said base, a bottom of said rubber support being aligned with a bottom of said switch support.

8. The boundary microphone of claim 7 wherein said switch support is constructed from plastic.
